(19) United States
(12) Patent Application Publication
(10) Pub. No.: US 2002/0000064 A1
(43) Pub. Date: Jan. 3, 2002

(54) Paper product, in particular calendar leaf, greeting card, visiting card

(76) Inventors: Uwe D'Agnone, Hennef (DE); Tim Schaefer, Bonn (DE)

Correspondence Address: David R. Schaffer, DILLER, RAMIK & WIGHT, Suite 101, 7345 McWhorter Place, Annandale, VA, 22003, US

(21) Appl. No.: 09/892,486

(22) Filed: Jun. 28, 2001

(30) Foreign Application Priority Data
Jun. 28, 2000 (DE) 200 11 014.4
Jul. 28, 2000 (EP) 00 116 374.0

(51) Int. Cl. A01C 1/00; G09F 1/00

(52) U.S. Cl. 47/1.01 R; 40/121

(57) ABSTRACT

A paper product (1), such as a greeting card, comprises two paper surfaces (2,3) glued to one another by means of an adhesive. Between said paper surfaces (2,3) at least one germinable seed-corn is arranged. According to the invention said germinable seed-corn is located in the area of a section (4). Said section (4) is separable from the paper product along a perforation (5).

### BACKGROUND OF THE INVENTION

The present invention relates to a paper product, in particular a calendar leaf, greeting card, visiting card etc., comprising two paper surfaces glued to one another by means of an adhesive, wherein at least one germinable seed-corn is arranged between the surfaces.

Such paper products are known from e.g. DE 298 23 151 U1. They are in particular used as gift, greeting and promotion articles, wherein the paper product containing the seed-corn can be planted in remembrance of the giver. However, said products have the drawback that information contained therein get lost when the products are planted.

### SUMMARY OF THE INVENTION

It is an object of the present invention to provide a paper product in which this drawback is eliminated.

According to the invention the paper product comprises a section which can be separated from the paper product. For this purpose a perforation is provided which facilitates the separation process. Since, according to the invention, the germinable seed-corn is contained in the separable section, only said section must be planted for the purpose of germinating the seed-corn. The remaining paper product can be continued to be used, e.g. if said product is a bookmarker or the like. The section is preferably arranged such that separation of the section does not affect the usability of the paper product. Information contained on the paper product is not destroyed by separation of the section. The paper product according to the invention further offers the advantage that only that portion of the paper product needs to be planted which contains the germinable seed-corn. Thus it is not necessary to plant a large amount of paper which might affect germination of the seed-corn.

Since the germinable seed-corn is contained in a section separable along a perforation, said section is easy to remove from the paper product and easy to plant. The section may have any geometric form, in particular round, rectangular or oval. Further, the section may comprise folding lines for producing a three-dimensional body, such as fanciful figures or everyday objects, e.g. a flower-pot.

To prevent harmful residues in garden mold the adhesive should be decomposable.

A calendar having a plurality of paper products described above has proved advantageous, wherein the paper products are coupled with each other via connecting elements, e.g. eye rings or an adhesive. The respective paper product may be divisible into a calendar leaf and a section, wherein said section may have the dimensions of a postcard.

Further, the paper product may be a visiting card which is divisible into an address field and a section containing the seed-corn.

### BRIEF DESCRIPTION OF THE DRAWINGS

Hereunder embodiments of the present invention are described in detail with reference to the drawings in which:

FIG. 1 shows a top view of a paper product according to the invention,

FIG. 2 shows the paper product of FIG. 1 with separated section,

FIG. 3 shows a perspective view of a calendar according to the invention, and

FIG. 4 shows a top view of a visiting card according to the invention.

### DESCRIPTION OF THE PREFERRED EMBODIMENTS

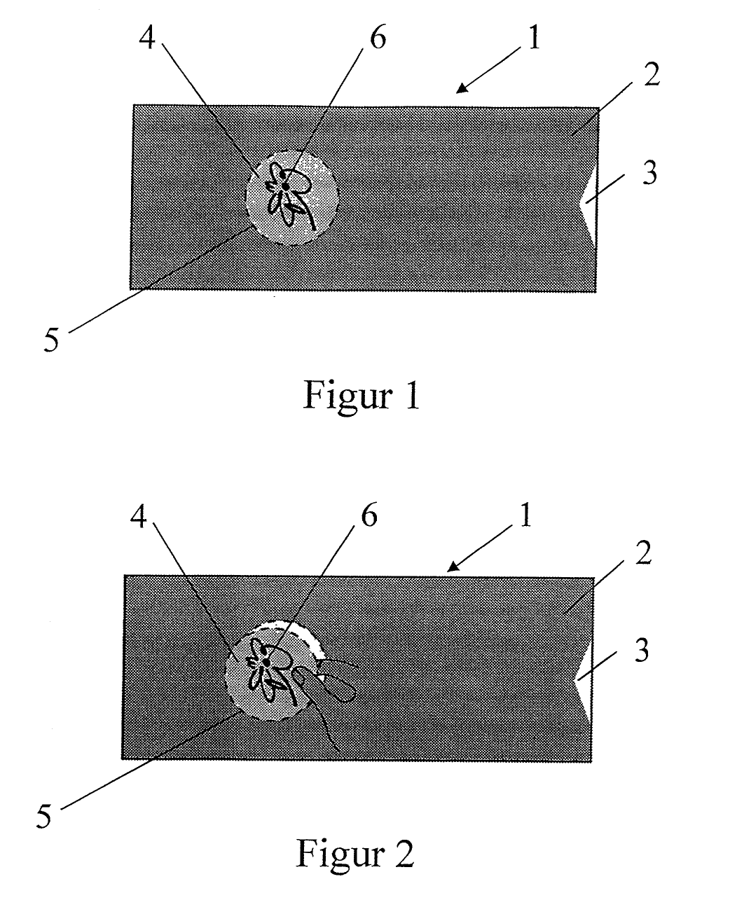

FIG. 1 shows a top view of a paper product 1 according to the invention which comprises two paper surfaces 2,3 glued to one another by means of an adhesive (for illustration purposes a triangular portion of the upper paper surface 2 has been omitted in the present embodiment). Between said paper surfaces 2,3 a germinable seed-corn (not shown) is contained in a section 4. In the present embodiment said section 4 is provided with a perforation 5 which forms a closed circle surrounding the seed-corn. Further, said section 4 may be provided with an inscription or a symbol 6 drawing the attention to the seed-corn contained therein.

FIG. 2 shows the paper product 1, wherein the section 4 has been separated. Said section 4 containing the germinable seed-corn is then easy to plant and the paper product 1, in this case e.g. a bookmarker, can be continued to be used. The section 4 shown here is of round configuration but may have any other geometric form.

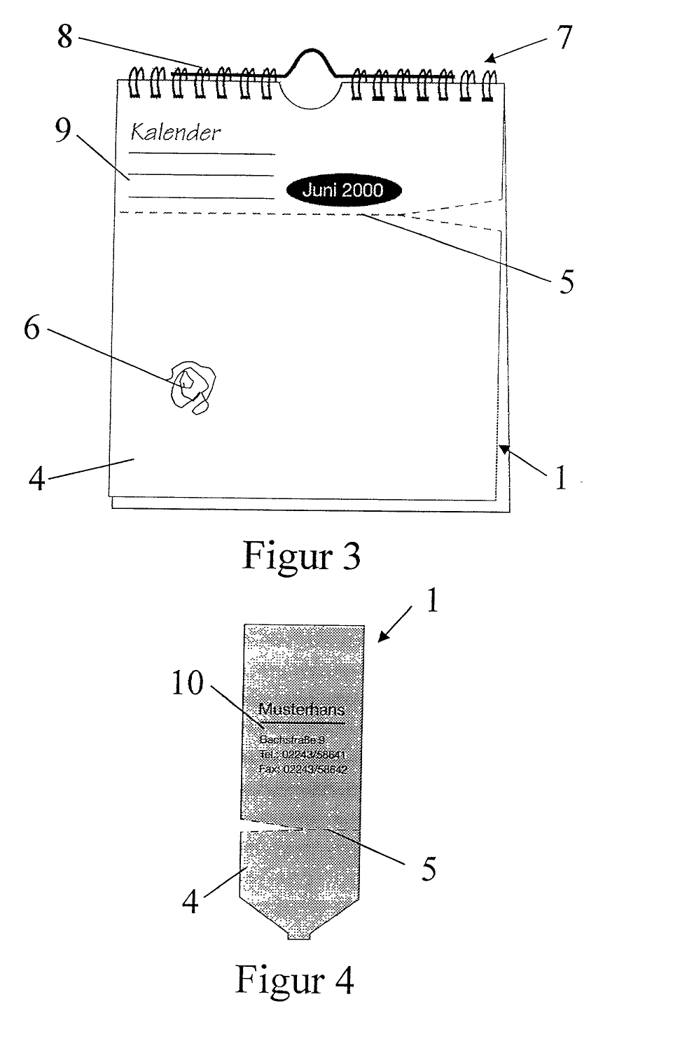

FIG. 3 shows a perspective view of a calendar 7 according to the invention, wherein individual paper products 1 are connected with each other via eye rings 8. The section 4 shown here is of rectangular configuration of the size of a postcard and is easy to separate from the calendar leaf 9 along the perforation 5. In this case, too, the place where the seed-corn is arranged is indicated by a symbol 6. It is to be noted that in the section 4, configured here as a postcard or a greeting card, another smaller section, as shown in FIG. 1, may be provided.

FIG. 4 shows a paper product 1 configured as a visiting card. The section 4 contains the germinable seed-corn. Said section 4 can be separated along the perforation 5 without the address field 10 and thus the visiting card proper being damaged.

It is to be noted that the invention relates to various paper products, including packing material, catalogs and the like.

Although preferred embodiments of the invention have been specifically illustrated and described herein, it is to be understood that minor variations may be made without departing from the spirit and scope of the invention, as defined in the appended claims.

What is claimed is:

1. Paper product, in particular a calendar leaf, greeting card, visiting card etc., comprising two paper surfaces (2,3) glued to one another by an adhesive, wherein at least one germinable seed-corn is arranged between said paper surfaces (2,3),
characterized in that
the germinable seed-corn is contained in a section (4) separable along a perforation (5).

2. Paper product according to claim 1, wherein the section (4) may have any geometric form, preferably round, rectangular or oval.

3. Paper product according to claim 1, wherein the section (4) comprises folding lines for producing a three-dimensional body.

4. Paper product according to claim 1, wherein the adhesive is a decomposable adhesive.

5. Calendar comprising a plurality of paper products according to claim 1, wherein said paper products (1) are coupled with each other by means of connecting elements (8), e.g. eye rings or an adhesive.

6. Calendar according to claim 5, wherein the respective paper product (1) is divisible into a calendar leaf (9) and a section (4).

7. Calendar according to claim 6, wherein the section (4) has the dimensions of a postcard.

8. Visiting card made from a paper product according to claim 1, wherein said paper product is divisible into an address field (10) and a section (4) with the perforation (5) being provided between the address field (10) and the section (4).

9. Greeting card made from a paper product according to claim 1, wherein said paper product is divisible into an inscription field and a section.
